(19) United States
(12) Patent Application Publication
(10) Pub. No.: US 2006/0277290 A1
(43) Pub. Date: Dec. 7, 2006

(54) COMPILING AND FILTERING USER RATINGS OF PRODUCTS

(76) Inventor: SAM SHANK, San Mateo, CA (US)

Correspondence Address: PERKINS COIE LLP, P.O. BOX 2168, MENLO PARK, CA, 94026, US

(21) Appl. No.: 11/422,066

(22) Filed: Jun. 2, 2006

Related U.S. Application Data
(60) Provisional application No. 60/687,116, filed on Jun. 2, 2005.

(51) Int. Cl. G06F 7/00; G06F 15/173; G06F 17/30; G07F 7/00

(52) U.S. Cl. 709/223; 707/7; 705/27

(57) ABSTRACT

A method, apparatus and system for compiling and filtering user ratings of products is provided. In one embodiment, a method is provided. The method includes receiving a location selection from a user at a website. The method also includes accessing reviews of hotels having a physical location near the location selection of the user. The reviews of hotels are submitted by users of the website. The method further includes calculating rankings of hotels having a physical location near the location selection of the user based on the reviews. The method also includes displaying a list of hotels having a physical location near the location selection of the user on the website for the user.

### CROSS-REFERENCE TO RELATED APPLICATION

This application claims priority to U.S. Provisional Patent Application No. 60/687,116, filed on Jun. 2, 2005, and hereby incorporated by reference herein.

### BACKGROUND

Computers have been networked to exchange data between them for decades. One important network, the Internet, comprises a vast number of computers and computer networks interconnected through communication channels. The Internet is used for a variety of reasons, including electronic commerce, exchanging information such as electronic mail, retrieving information and doing research, and the like. Many standards have been established for exchanging information over the Internet, such as electronic mail, Gopher, and the World Wide Web (“WWW”). The WWW service allows a server computer system (i.e., web server or web site) to send graphical web pages of information to a remote client computer system. The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends the requested web page to the client computer system. When the client computer system receives that web page, it typically displays the web page using a browser. A browser is typically a special purpose application program for requesting and displaying web pages.

Currently, web pages are often defined using HyperText Markup Language (“HTML”). HTML provides a standard set of tags that define how a web page is to be displayed. When a user makes a request to the browser to display a web page, the browser sends the request to the server computer system to transfer to the client computer system an HTML document that defines the web page. When the requested HTML document is received by the client computer system, the browser displays the web page as defined by the HTML document. The HTML document contains various tags that control the display of text, graphics, controls, and other features. The HTML document may contain URLs of other web pages available on that server computer system or on other server computer systems.

New protocols exist, such as Extensible Mark-up Language (“XML”) and Wireless Access Protocol (“WAP”). XML provides greater flexibility over HTML. WAP provides, among other things, the ability to view web pages over hand-held, wireless devices, such as cell phones and portable computers (e.g. PDA's). All of these protocols provide easier ways to provide information to people via various data processing devices. Many other protocols and means for exchanging data between data processing devices continue to develop to further aid the exchange of information.

Presently, consumer information can be found on the WWW. However, the information tends to be of limited availability. For example, a single reviewer may post a web page with specific reviews. Many such reviews may be searched for and effectively surveyed, providing a wider understanding of the consensus of such reviews. Alternatively, reviews may be posted on a central web page location, where reviews of many users are posted. Reading these reviews on such a site may provide a similar consensus. However, it may be useful to provide an opportunity to customize these reviews based on what products are reviewed, or whose comments are included.

### BRIEF DESCRIPTION OF THE DRAWINGS

The present invention is illustrated by way of example in the accompanying drawings. The drawings should be understood as illustrative rather than limiting.

FIG. 1 is a block diagram of a basic and suitable computer that may employ aspects of the invention.

FIG. 2A is a block diagram illustrating a simple, yet suitable system in which aspects of the invention may operate in a networked computer environment.

FIG. 2B is a block diagram illustrating an alternative system to that of FIG. 2A.

FIG. 3 illustrates an embodiment of a website graphical user interface.

FIG. 4 illustrates another view of the website of FIG. 3.

FIG. 5 illustrates a flow diagram of an embodiment of a method of operating a website.

FIG. 6 illustrates an alternate embodiment of a website graphical user interface.

FIG. 7 illustrates another view of the website of FIG. 6.

FIG. 8 illustrates yet another view of the website of FIG. 6.

FIG. 9 illustrates still another view of the website of FIG. 6.

FIG. 10 illustrates an embodiment of a machine-readable medium embodying a system for displaying rankings of products or services.

FIG. 11 illustrates another view of the website of FIG. 6.

FIG. 12 illustrates yet another view of the website of FIG. 6.

FIG. 13 illustrates still another view of the website of FIG. 6.

FIG. 14 illustrates another alternate embodiment of a website graphical user interface.

FIG. 15 illustrates another view of the website of FIG. 14.

Note: the headings provided herein are for convenience and do not necessarily affect the scope or interpretation of the invention.

### DETAILED DESCRIPTION

The invention is provided in various embodiments, some of which will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

A method, apparatus and system for compiling and filtering user ratings of products is provided. In one embodiment, a method is provided. The method includes receiving a location selection from a user at a website. The method also includes accessing reviews of hotels having a physical location near the location selection of the user. The reviews of hotels are submitted by users of the website. The method further includes calculating rankings of hotels having a physical location near the location selection of the user based on the reviews. The method also includes displaying a list of hotels having a physical location near the location selection of the user on the website for the user.

In another embodiment, a system is provided. The system includes a processor. The system also includes a user interface coupled to the processor. The system further includes a network interface coupled to the processor. The system also includes a local storage medium coupled to the processor. The processor is to implement a website. The processor is further to receive a location selection from a user at the website. Also, the processor is to access reviews of hotels having a physical location near the location selection of the user. The reviews of hotels are submitted by users of the website. Moreover, the processor is to calculate rankings of hotels having a physical location near the location selection of the user based on the reviews. Also, the processor is to display a list of hotels having a physical location near the location selection of the user on the website for the user.

In another embodiment, a method is provided. The method includes receiving a location selection from a user at a website. Also, the method includes receiving a selection of hotel filtering parameters from the user. Furthermore, the method includes receiving a selection of review filtering parameters from the user. Moreover, the method includes filtering hotels from the hotels having a physical location near the location selection of the user based on the hotel filtering parameters to produce a filtered set of hotels.

Additionally, the method includes accessing reviews of hotels of the filtered set of hotels. The reviews of hotels are submitted by users of the website. Also, the method includes filtering the accessed reviews based on the review filtering parameters to produce a filtered set of reviews. Further, the method includes calculating rankings of hotels having a physical location near the location selection of the user based on the filtered set of reviews. Additionally, the method includes displaying a list of hotels having a physical location near the location selection of the user on the website for the user based on the filtered set of hotels, the filtered set of reviews and the rankings.

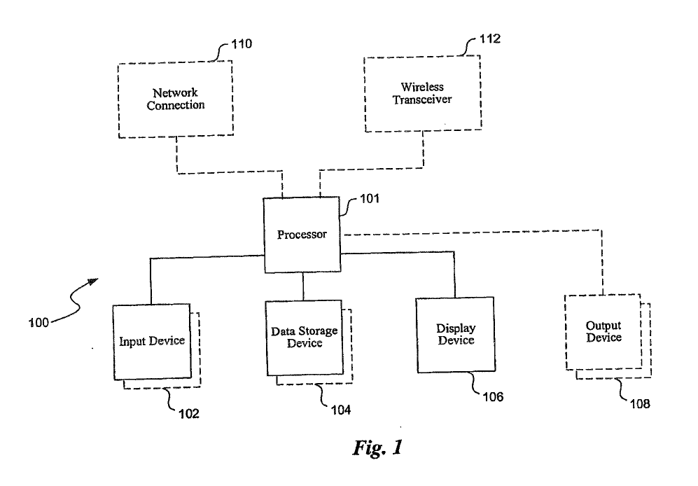

FIG. 1 and the following discussion provide a brief, general description of a suitable computing environment in which aspects of various embodiments can be implemented. Although not required, aspects and embodiments will be described in the general context of computer-executable or machine-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention thus may be embodied as a set of instructions in a machine-readable medium, which, when executed by a processor, cause the processor to perform a method. The invention can also be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

Embodiments may also be found in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 1, one embodiment employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can embody data accessible by the computer 100, such as magnetic hard and floppy disk drives, optical disk drives, magnetic cassettes, tape drives, flash memory cards, digital video disks (DVDs), Bernoulli cartridges, RAMs, ROMs (including EEPROM and similar ROMs), smart cards, etc. Indeed, any medium for storing or transmitting computer-readable instructions and data may be employed, including a connection port to or node on a network such as a local area network (LAN), wide area network (WAN) or the Internet (not shown in FIG. 1).

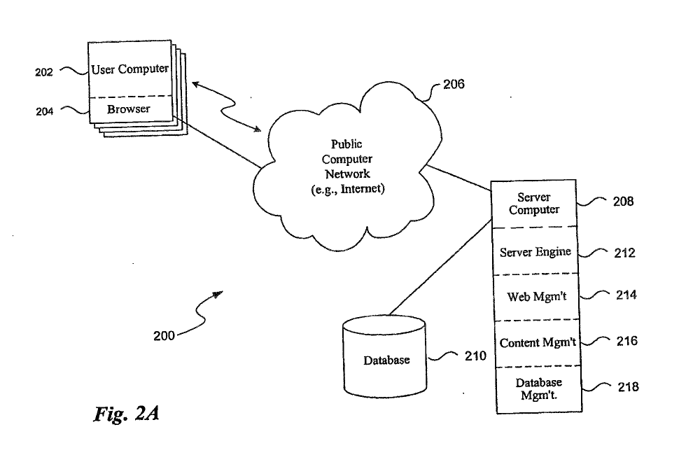

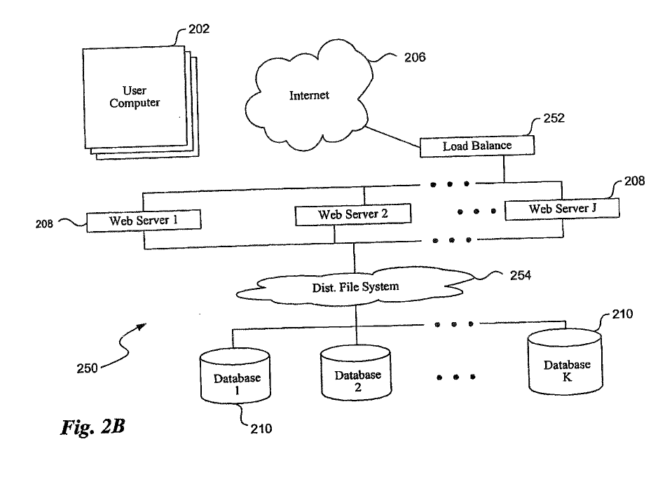

Aspects of the invention may be practiced in a variety of other computing environments. For example, referring to FIG. 2A, a distributed computing environment with a web interface including one or more user computers 202 in a system 200 is shown, each computer of which includes a browser program module 204 that permits the computer to access and exchange data with the Internet 206, including web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer architecture, in which one or more computers serve simultaneously as servers and clients. A database 210 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data such as video, graphics and audio signals.

Referring to FIG. 2B, an alternative embodiment to the system 200 is shown as a system 250. The system 250 is substantially similar to the system 200, but includes more than one server computer (shown as server computers 1, 2, . . . J). A load balancing system 252 balances load on the several server computers. Load balancing is a technique well-known in the art for distributing the processing load between two or more computers, to thereby more efficiently process instructions and route data. Such a load balancer can distribute message traffic, particularly during peak traffic times.

A distributed file system 254 couples the web servers to several databases (shown as databases 1, 2 . . . K). A distributed file system is a type of file system in which the file system itself manages and transparently locates pieces of information (e.g., content pages) from remote files or databases and distributed files across the network, such as a LAN. The distributed file system also manages read and write functions to the databases.

Further details on the invention are provided below.

Various embodiments provide a way to customize and personalize user ratings of products such as hotels or other consumer services and goods. This may be described, in some embodiments as: For ratings of product and services based on multiple user scores where demographic and other information about the users is collected, dynamically re-calculate and re-order products and scores as a result of a researcher/shopper actively filtering and selecting certain reviewer attributes. This process can produce personalized recommendations, more accurate and informative to the researcher than recommendations from every user.

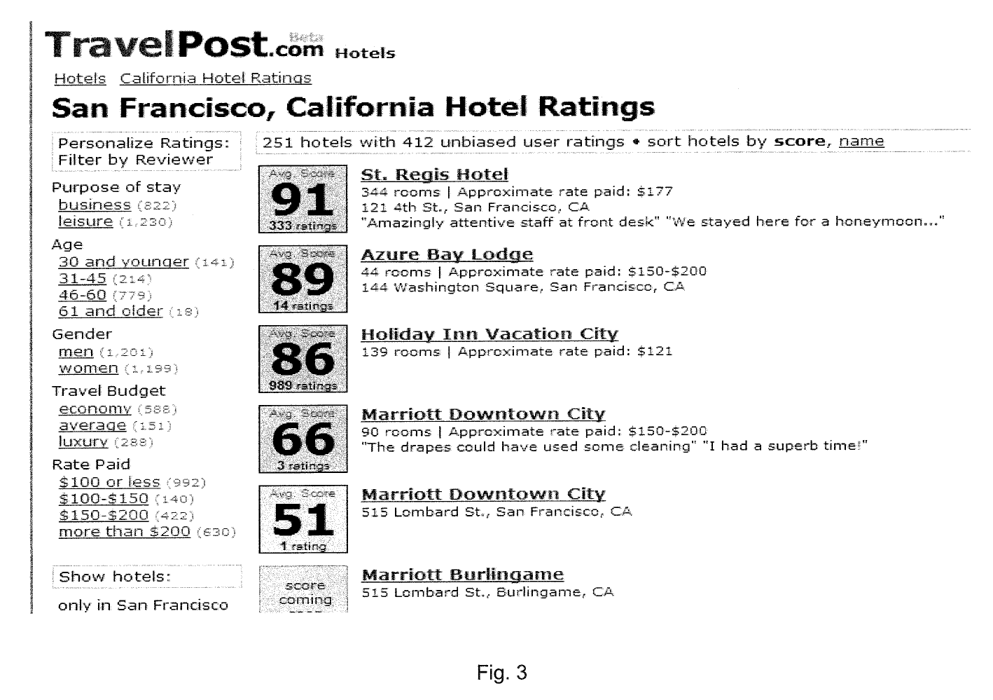

When a user is on a product category page, such as San Francisco hotels, they see a list of products within that category ranked by user score (such as is illustrated in FIG. 3). The score is a weighted average of multiple, individual user scores. Aside from the products (e.g. hotels), users are presented with a variety of filtering options, which enable users to see ratings from a subset of users with the defined classification, such as gender, age, budget, etc.

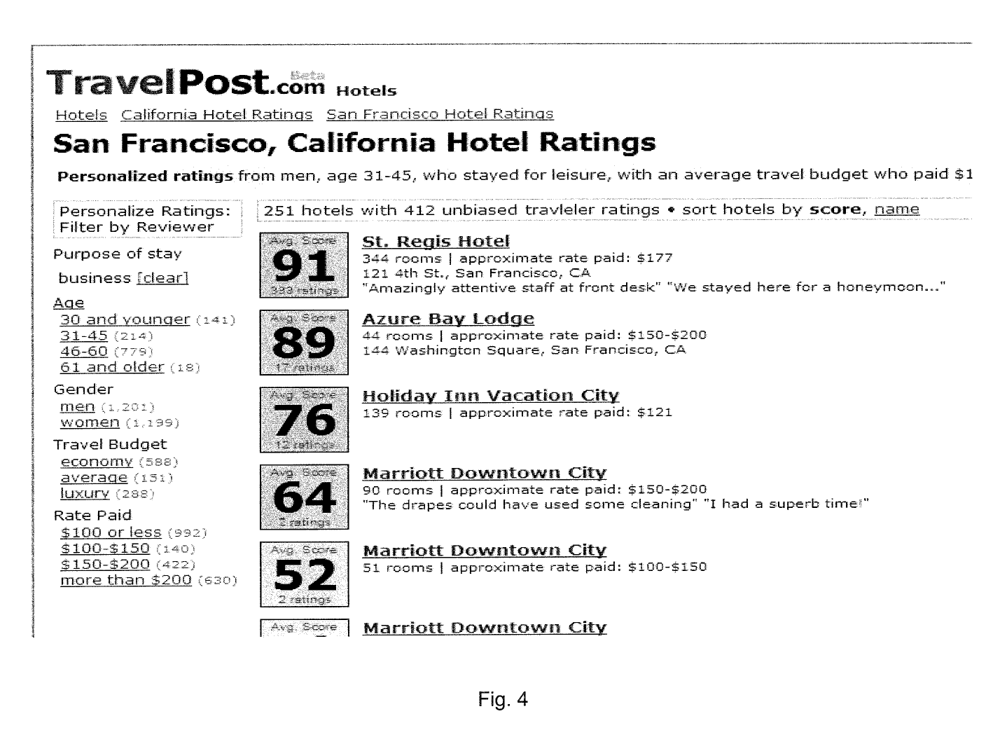

When such a filter is selected, the set of user ratings is decreased, but the set of products remains constant. The system recalculates average user score and re-sorts the products by average user score, thereby presenting customized hotel results (such as is illustrated in FIG. 4). Similarly, on a product page, a user can select filters to customize reviews for that single product. In implementation, for cities such as New York with hundreds of hotels and thousands of user ratings, this process may involve conducting tens of thousands of calculations in order to display the appropriate information. Moreover, for processing information about more broadly available generic products or services (on-line brokerages or baseballs, for example), the number of users may be very large even though the number of product offerings is small.

In some embodiments, users can save a preferred set of filters to a profile which describe them and their travel preferences. For example, a user can say he is a 55 year old male with an average travel budget. By saving these preferred filters, the user can quickly personalize the ratings on a product category page or a product page, via a single click on a “show ratings from users like me” button or similar graphical user interface feature.

The process of a user selecting preferred filters can be done via a profile page to select options. Alternatively, it may be done as a result of the system collecting information when the user writes a new hotel review (which requires the user to enter the demographic information used by the filters). Likewise, it may be done as a result of the system saving previous filter selections and giving the user an opportunity to reselect the filters with a single click.

Customization of ratings may be based on information passively-collected by the software. These elements may include products viewed by the user, time spent viewing each product, products saved to a favorites or wish list, members added to a list of favorite members, and the hotel ratings of members added to a list of favorite members. These passive elements may enable the software to tell how similar the user is to other users, and thereby weight and display individual ratings from similar users.

One embodiment of a website uses hotel ratings and reviews of products in order to provide users with customized hotel reviews. Reviews of products and services may also involve, for example, other travel categories, such as cruises, bed and breakfasts, vacation rentals, restaurants and destination activities. Similarly, other embodiments can be applied to any category of products or services where reviews can aid the buying process, such as electronics and computers, sports equipment, music and books and electricians.

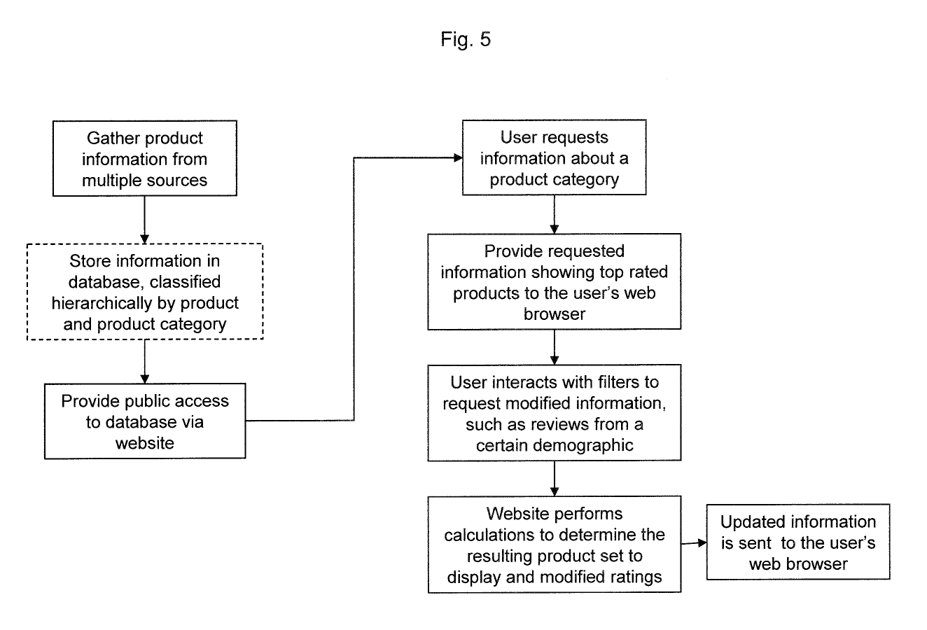

FIG. 5 illustrates a process for gathering and displaying this information. The process begins by gathering information about the products or services in question, such as from reviews by users. The information is then stored in a database. The data is then made available to the public through a website. A user then requests information about a specific product or service. The website then provides the requested information about the product or service to the user—drawing the information related to the product or service from the database. The user then interacts with available filters to determine how to customize the data. The website then recalculates the ratings and product/service information based on the desired filter properties. The website then provides the recalculated information to the user for review.

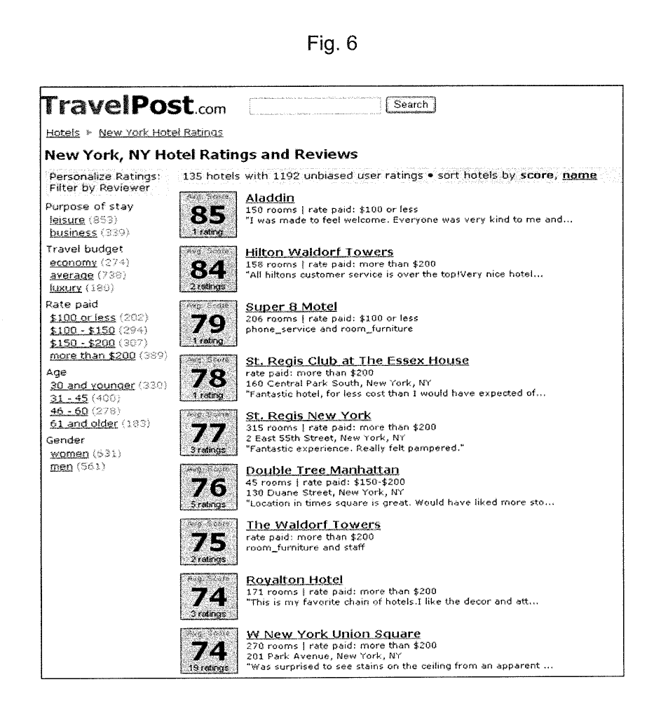

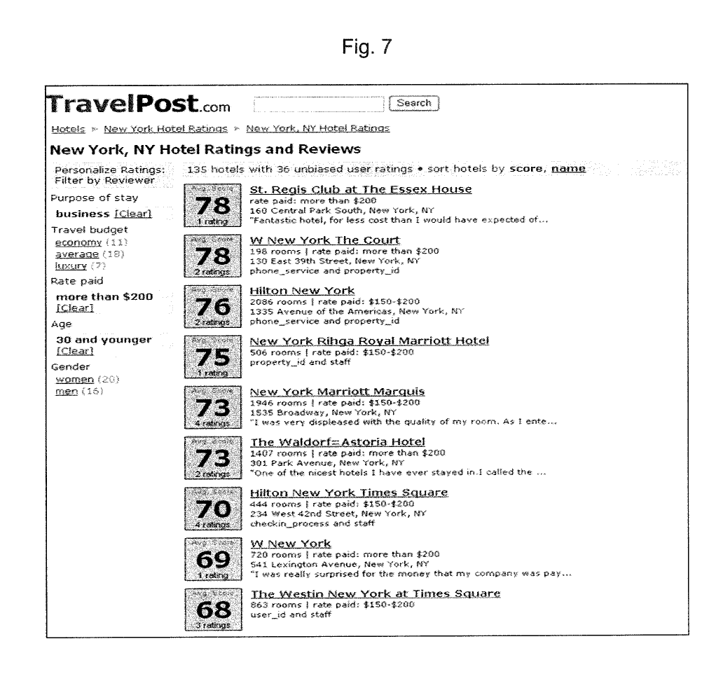

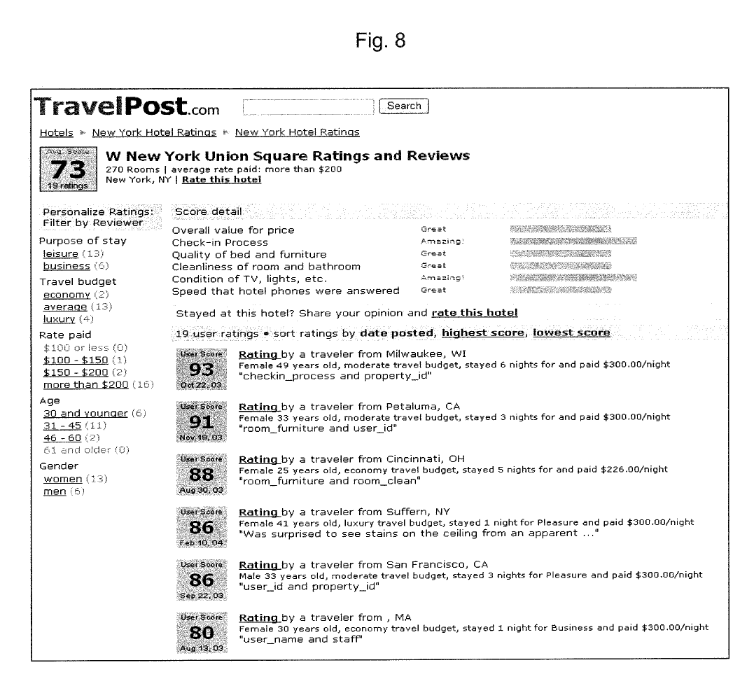

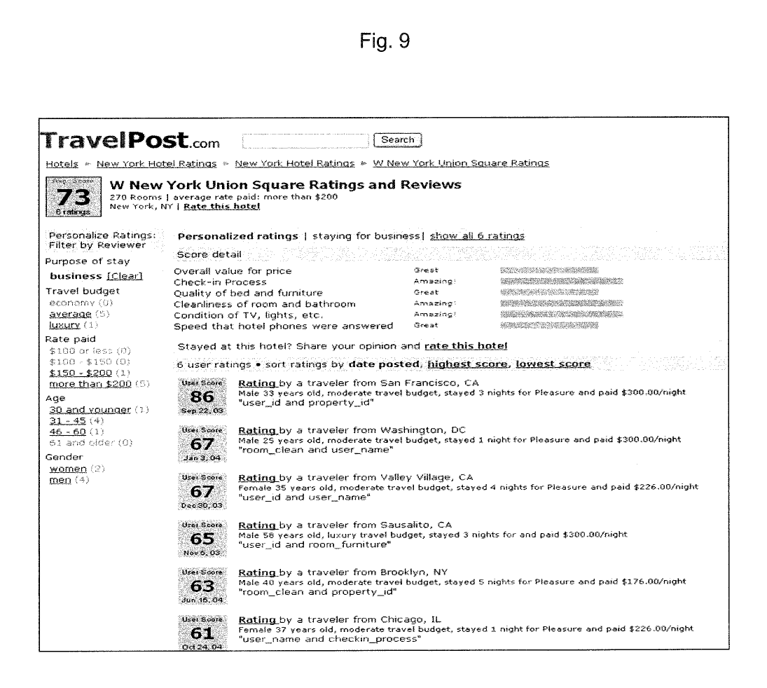

FIG. 6 illustrates an initial presentation of data on New York hotel ratings. FIG. 7 illustrates the New York hotel ratings after filtration—with fewer user inputs, but user inputs tailored to aspects of the user profile. Similarly, FIG. 8 illustrates an initial presentation of Union Square (New York) hotel ratings. FIG. 9 illustrates a filtered presentation of Union Square hotel ratings.

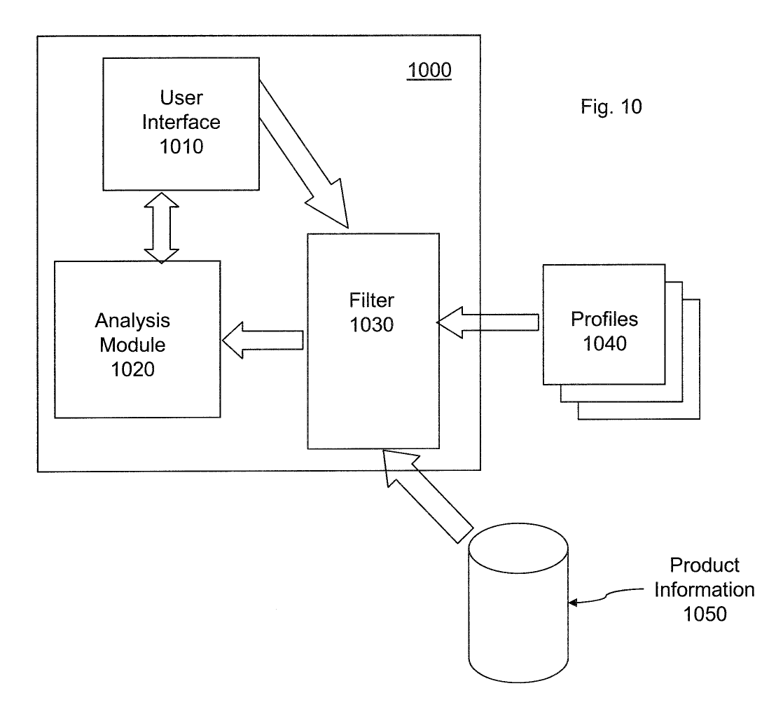

FIG. 10 illustrates an embodiment of a machine-readable medium. The machine-readable medium embodies instructions which may be executed by a processor. The processor, executing the instructions, implements a method or system for displaying ratings of products or services.

Medium 1000 includes a user interface, analysis module and filter. Medium 1000 works with a set of profiles and a product or server database. User interface 1010 is a graphical user interface, which may be operated from a server or a client, and interacts with a user to receive input and display output. Analysis module 1020 is a computational module which synthesizes ratings data into a displayable format of ratings of particular products or services.

Filter 1030 is a module which filters out user profiles and associated ratings information based on user specifications or default specifications. Filter 1030 receives an indication from user interface 1010 of what should be filtered out (or left in), such as desired age ranges, types of consumers/profiles, or types of products/services, for example. If nothing is filtered out, all user profiles 1040 and database information 1050 related to desired products are used for calculations by analysis module 1020. If an age range is selected, for example, then only profiles 1040 fitting the selected age range are used for calculations by the analysis module 1020. Only profiles 1040 and data fitting the filter requirements are passed through or requested by filter 1030.

Filter 1030 may be a filter which blocks information not fitting a set of filter criteria received from user interface 1010. Alternatively, filter 1030 may be a module which requests data from product/service database 1050 and profiles 1040. These requests may be shaped based on the set of filter criteria.

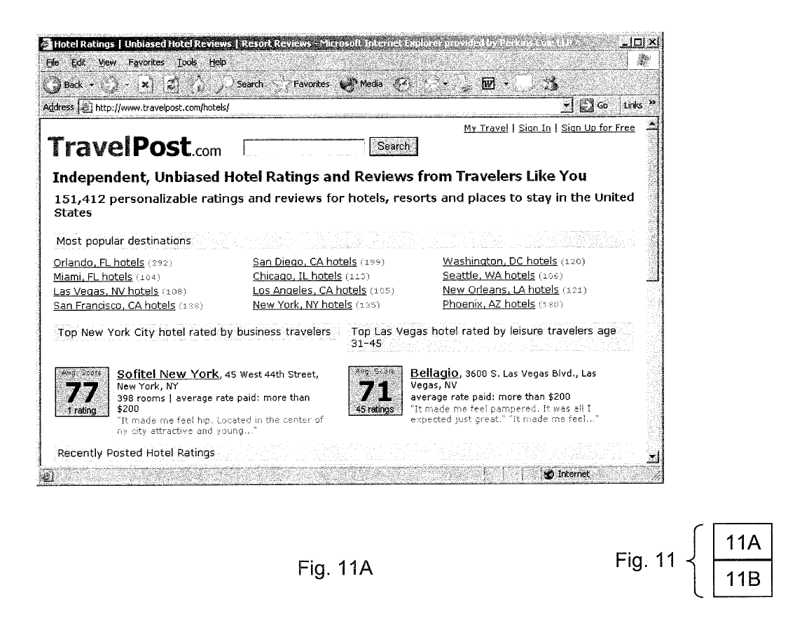

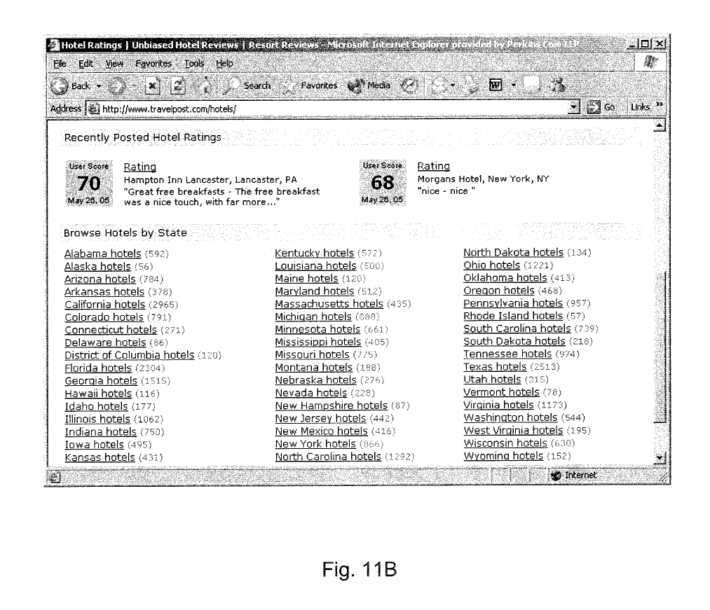

Additional views of the website of FIG. 6 may also be useful. FIG. 11 illustrates another view of the website of FIG. 6. More specifically, FIG. 11 illustrates an opening screen of the website of FIG. 6, with FIG. 11A showing most popular destinations and top hotels in some categories, and FIG. 11B showing recently posted ratings and a listing of links to states in the United States where hotels may be found.

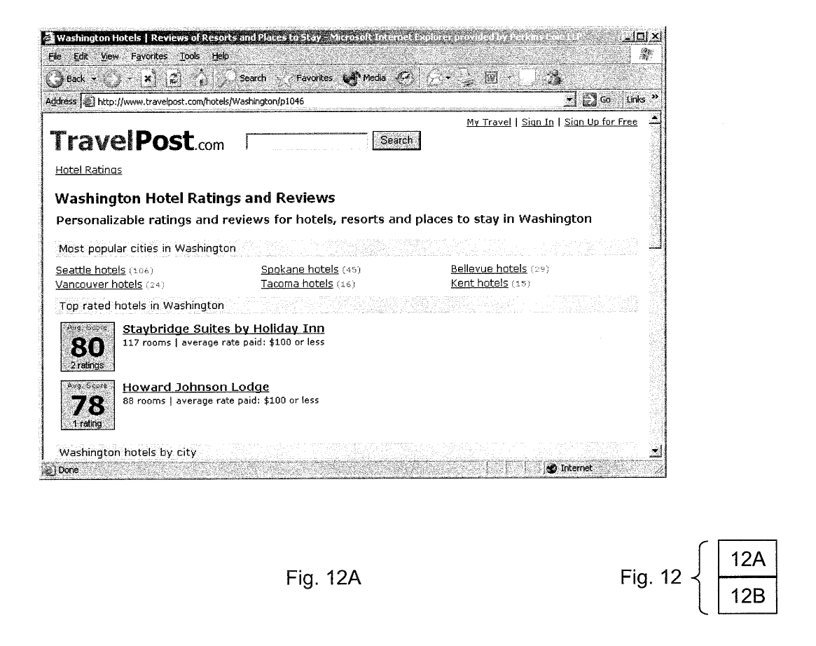

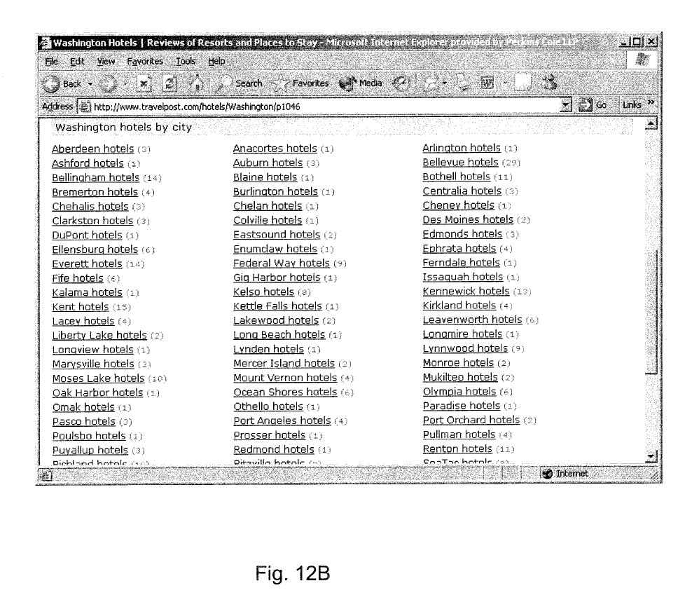

Upon selecting Washington state, another view of the website is displayed. FIG. 12 illustrates yet another view of the website of FIG. 6. FIG. 12A displays most popular cities in Washington state and top-rated hotels in Washington state. FIG. 12B displays a listing of links to cities in Washington state in which hotels may be available.

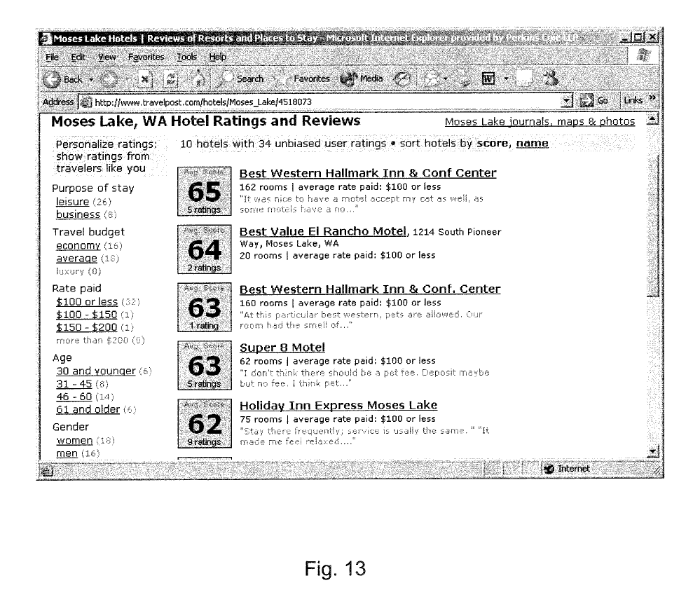

Upon selecting a city or town (Moses Lake in this instance), yet another view of the website is displayed. FIG. 13 illustrates still another view of the website of FIG. 6. The website indicates that 10 hotels have been rated in Moses Lake (only some of which are shown). The website may be scrollable to provide views of all such hotels, or may provide a view of a limited number of hotels with an opportunity to display a next set of such hotels, for example. The hotels are displayed based on ratings from within the website. Additionally, choices for filters are provided on the left side of the website, allowing a user to tailor ratings based on choices such as gender, age range, rate paid, or travel budget, for example.

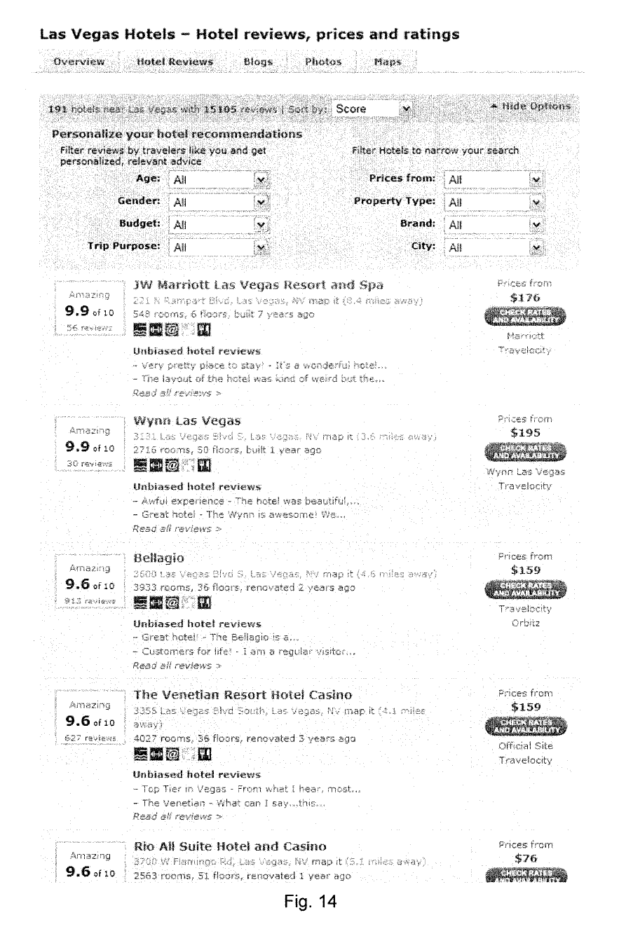

Other embodiments of a website may be implemented to provide similar features and functionality. FIG. 14 illustrates another alternate embodiment of a website graphical user interface. In this embodiment, as with other embodiments, information on hotels or similar travel-related goods or services can be displayed. In particular, hotels in Las Vegas are displayed. As illustrated, the hotels are listed based on rank or score—a rating of the hotel. However, other attributes of the hotel, such as price or location for example, may be used to order the list. Also provided are tabs allowing for access to related information, such as a blog, photo, or map that is related to the hotel or list of hotels.

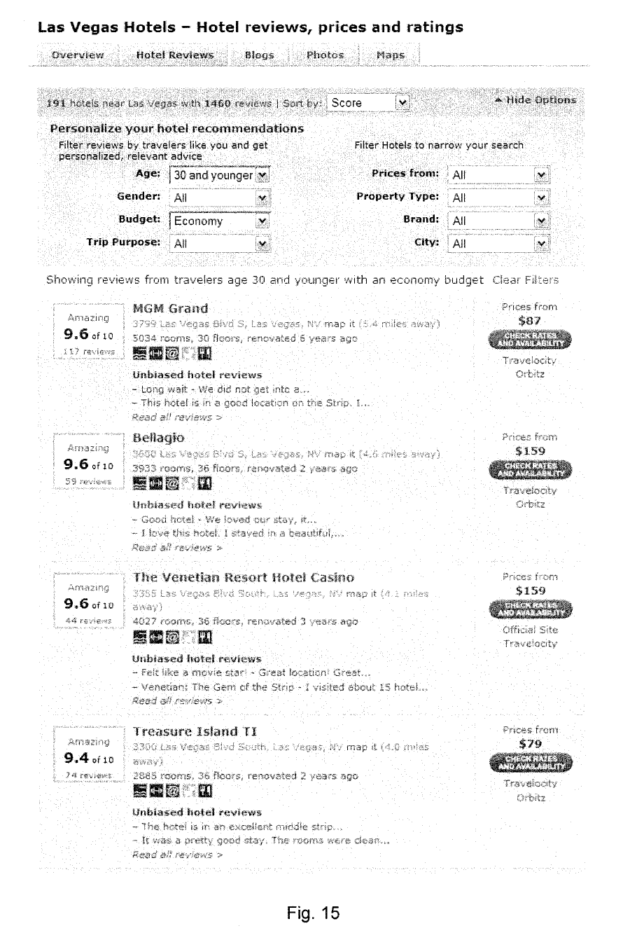

Hotel listings may be filtered, based on various characteristics. FIG. 15 illustrates another view of the website of FIG. 14. For example, drop-down menus are provided to allow for selection of filtering characteristics. Thus, a user may filter based on characteristics of reviewers of a hotel, such as age, gender, budget or type of trip (business or pleasure for example). Other similar characteristics may be collected from reviewers of hotels and used for such filtering. Similarly, hotels may be filtered based on more objective criteria related directly to the hotel, such as prices, type of property, brand, and city, for example. As illustrated in FIG. 15, hotel results may be filtered to use ratings only from travelers aged 30 or younger with economy budgets, resulting in a different listing for the same general area.

In general, the detailed description of embodiments is not intended to be exhaustive or to limit the invention to the precise form disclosed above. While specific embodiments and examples are described above for illustrative purposes, various equivalent modifications to produce other embodiments are possible. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the invention may be stored, embodied or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of various embodiments may be distributed over the Internet or over other networks (including wireless networks), on a propagated signal on a propagation medium (e.g., an electromagnetic wave(s), a sound wave, etc.) over a period of time, or may be provided on any analog or digital network (packet switched, circuit switched, or other scheme). Portions of various embodiments may reside on a server computer, while corresponding portions reside on a client computer such as a mobile or portable device, and thus, while certain hardware platforms are described herein, aspects of the embodiments are equally applicable to nodes on a network.

The teachings of the invention provided herein can be applied to other systems, potentially differing from the system described herein. The elements, components and acts of the various embodiments described herein may be combined or may be subdivided to provide further embodiments. Aspects of the invention can be modified, if necessary, to employ the systems, functions, and concepts of well-known references to provide yet further embodiments of the invention.

While the above description details certain embodiments of the invention and describes the best mode contemplated, no matter how detailed the above appears in text, the invention can be practiced in many ways. Details of various embodiments may vary considerably in its implementation details. As noted above, particular terminology used when describing certain features or aspects should not be taken to imply that the terminology is being redefined herein to be restricted to any specific characteristics, features, or aspects with which that terminology is associated. In general, the terms used in claims should not be construed to limit the invention to the specific embodiments disclosed in the specification, unless the above Detailed Description section explicitly defines such terms. Accordingly, the invention encompasses not only the disclosed embodiments, but also all equivalent ways of practicing or implementing the invention.

What is claimed is:

1. A method, comprising:
receiving a location selection from a user at a website;
accessing reviews of hotels having a physical location near the location selection of the user, the reviews of hotels submitted by users of the website;
calculating rankings of hotels having a physical location near the location selection of the user based on the reviews; and
displaying a list of hotels having a physical location near the location selection of the user on the website for the user.

2. The method of claim 1, wherein:
the hotels are displayed in a list ranked based on scores derived from the reviews of hotels having a physical location near the location selection of the user.

3. The method of claim 1, wherein:
the hotels are displayed in a list ranked based on prices of the hotels of the list.

4. The method of claim 1, wherein:
the hotels are displayed in a list ranked based on distance from the location selection of the hotels of the list.

5. The method of claim 1, wherein:
the hotels are displayed in a list ranked based on prices of the hotels of the list.

6. The method of claim 1, further comprising:
receiving a selection of review filtering parameters from the user;
filtering the accessed reviews based on the review filtering parameters to produce a filtered set of reviews;
and wherein:
calculating occurs based on the filtered set of reviews.

7. The method of claim 6, wherein:
the review filtering parameters include age of reviewers.

8. The method of claim 6, wherein:
the review filtering parameters include budget of reviewers.

9. The method of claim 6, wherein:
the review filtering parameters include gender of reviewers.

10. The method of claim 1, further comprising:
receiving a selection of hotel filtering parameters from the user;
filtering hotels from the hotels having a physical location near the location selection of the user based on the hotel filtering parameters to produce a filtered set of hotels; and
calculating occurs and displaying occurs only based on the filtered set of hotels.

11. The method of claim 10, wherein:
the hotel filtering parameters include price of hotels.

12. The method of claim 10, wherein:
the hotel filtering parameters include type of hotels.

13. The method of claim 10, wherein:
the hotel filtering parameters include brand of hotels.

14. The method of claim 1, further comprising:
receiving a selection of hotel filtering parameters from the user;
receiving a selection of review filtering parameters from the user;
filtering hotels from the hotels having a physical location near the location selection of the user based on the hotel filtering parameters to produce a filtered set of hotels;
filtering the accessed reviews based on the review filtering parameters to produce a filtered set of reviews;
and wherein:
accessing occurs based on the filtered set of hotels;
calculating occurs based on the filtered set of reviews; and
calculating occurs and displaying occurs based on the filtered set of hotels.

15. The method of claim 1, further comprising:
monetizing user interaction with the website through one or more of the group consisting of advertising, subscription fees, listing fees or referral fees.

16. The method of claim 1, wherein:
the method is implemented by a processor, the processor executing a set of instructions embodied in a machine-readable medium, the processor implementing the method responsive to execution of the instructions.

17. A method, comprising:
receiving a location selection from a user at a website;
receiving a selection of hotel filtering parameters from the user;
receiving a selection of review filtering parameters from the user;
filtering hotels from the hotels having a physical location near the location selection of the user based on the hotel filtering parameters to produce a filtered set of hotels;
accessing reviews of hotels of the filtered set of hotels, the reviews of hotels submitted by users of the website;
filtering the accessed reviews based on the review filtering parameters to produce a filtered set of reviews;
calculating rankings of hotels having a physical location near the location selection of the user based on the filtered set of reviews; and
displaying a list of hotels having a physical location near the location selection of the user on the website for the user based on the filtered set of hotels, the filtered set of reviews and the rankings.

18. A system, comprising:
a processor;
a user interface coupled to the processor;
a network interface coupled to the processor;
a local storage medium coupled to the processor;
and wherein the processor is to:
implement a website,
receive a location selection from a user at the website,
access reviews of hotels having a physical location near the location selection of the user,
and wherein the reviews of hotels submitted by users of the website,
the processor is further to:
calculate rankings of hotels having a physical location near the location selection of the user based on the reviews, and
display a list of hotels having a physical location near the location selection of the user on the website for the user.

19. The system of claim 18, wherein:
the processor is further to:
receive a selection of review filtering parameters from the user,
filter the accessed reviews based on the review filtering parameters to produce a filtered set of reviews,
and wherein the processor is to calculate rankings of hotels based on the filtered set of reviews.

20. The system of claim 18, further comprising:
means for receiving a selection of review filtering parameters from the user;
means for filtering the accessed reviews based on the review filtering parameters to produce a filtered set of reviews;
and wherein the processor is to calculate rankings of hotels based on the filtered set of reviews.
